(19) United States
(12) Patent Application Publication
(10) Pub. No.: US 2016/0323266 A1
(43) Pub. Date: Nov. 3, 2016

(54) METHOD, MANAGEMENT APPARATUS AND DEVICE FOR CERTIFICATE-BASED AUTHENTICATION OF COMMUNICATION PARTNERS IN A DEVICE

(71) Applicant: SIEMENS AKTIENGESELLSCHAFT, München (DE)

(72) Inventors: UWE BLÖCHER, PUCHHEIM (DE); RAINER FALK, POING (DE); STEFFEN FRIES, BALDHAM (DE)

(21) Appl. No.: 15/107,626

(22) PCT Filed: Dec. 17, 2014
(86) PCT No.: PCT/EP2014/078167

§ 371 Date: Jun. 23, 2016

(30) Foreign Application Priority Data
Jan. 23, 2014 (DE) 10 2014 201 234.1

(51) Int. Cl. H04L 29/06; H04L 9/32

(52) U.S. Cl. CPC H04L 63/0823; H04L 9/3268; H04L 63/101

(57) ABSTRACT

A certificate-based authentication of communication partners in a device is provided and has the first method step of identification of a target frame for the device. All permitted communication partners for the identified target frame are ascertained from a total quantity of possible communication partners, and a positive list that is specific to the target frame and that includes a respective certificate for each ascertained permitted communication partner is produced. In the next method step, the positive list is stored on the device. A certificate received from a purported communication partner in the device is checked against the certificates in the positive list, with communication between the device and the purported communication partner being permitted only if the certificate from the purported communication partner matches a certificate in the positive list.

### CROSS-REFERENCE TO RELATED APPLICATIONS

This application claims priority to PCT Application No. PCT/EP2014/078167, having a filing date of Dec. 17, 2014, based off of DE Application No. 102014201234.1 having a filing date of Jan. 23, 2014, the entire contents of which are hereby incorporated by reference.

### FIELD OF TECHNOLOGY

The following relates to a method, a management apparatus and a device for a certificate-based authentication of communication partners in a device in a communication environment.

### BACKGROUND

In industrial automation systems, communication takes place increasingly by means of open protocols such as the Internet protocol (IP), the transfer control protocol (TCP), the user data gram protocol (UDP), the hypertext transfer protocol (HTTP) or else an application protocol constricted in accordance with the devices used (CoAP). The standardized architecture protocol (OPCUA) or the message queue telemetry transfer protocol (MQTT) are also used for communication. To guarantee transmission security and the authenticity of the communication partners, cryptographic methods are mostly used. For the methods, asymmetric methods are frequently used in which different keys are used in each case for a transmitter and a receiver.

For the authentication of a communication partner in a device, a certificate of the communication partner is usually checked and recognized as valid when the entries of the certificate are tested as valid and when it has been issued by a trustworthy certification office. Accepted certificates are typically restricted on the basis of a certificate revocation list (CRL) in which certificates which have become invalid during their currency, i.e. revoked certificates, are entered. This provides for open communication with many communication partners since a communication partner can be authenticated by means of its certificate.

Whether a communication partner is authorized for communication with the device is checked by means of access control information or an enquiry in an access control server. This results in a high data stream in the form of control messages via the communication network particularly in a communication network such as, for example, an automation network, in which permitted communication relations are known in advance due to, for example, projection data.

### SUMMARY

An aspect relates to reduce the occurrence of control messages in a communication network, particularly with a predetermined restricted circle of permitted communication partners and to restrict communication to these known partners and to protect communication against intentional attacks, particularly of communication partners not permitted.

The method according to embodiments of the invention for a certificate-based authentication of communication partners in a device has as the first method step the identifying of a target frame for the device. This is followed by ascertaining all permitted communication partners for the identified target frame from a total quantity of possible communication partners and producing a positive list specific to the target frame which in each case comprises a certificate for each ascertained permitted communication partner. In the next method step, the positive list is stored on the device. A certificate received from a purported communication partner in the device is checked against the certificates in the positive list, with a communication between device and the purported communication partner being permitted only if the certificate of the purported communication partner matches a certificate in the positive list.

Thus, each device in the communication environment can authenticate a permitted communication partner independently and without performing an interrogation in an external access control server. This thus reduces the number and bandwidth of control messages in the communication network. In addition, only one communication with permitted communication partners can be predetermined and set up in advance by using a positive list. This reduces the possible attacks by attackers without permission and particularly hostile attackers.

In an advantageous embodiment, the target frame of the device is identified by specification of a device type and/or of a purpose of use of the device and/or of a permitted geographic field of use of the device.

By this means, positive lists can be generated in a targeted manner for different devices which, however, have the same target frame, and used in all these devices with the corresponding target frame. Thus, a separate positive list does not necessarily need to be generated for each individual device. By specifying a device type or a geographic field of use, dedicated or else several positive lists can thus be selected for a device. In this context, an individual device can support an individual positive list which is used uniformly for all communication relations of the device. An individual device can also support a number of positive lists which are used in each case for a particular subset of the communication relations. Thus, for example a first positive list can be used for the transmission of control data and measuring data and a second positive list can be used for a diagnosis communication.

The positive list of the certificates can be derived in several ways. It can be derived, for example, service-specifically or device-specifically or from a combination of services, devices and further information. However, generally, arbitrary criteria can be used for delimiting the target frame of a positive list.

In an advantageous embodiment, further conditions relating to the validity of a certificate are entered in the positive list.

For example, this enables the validity of a certificate to be coupled to the operating mode of the device or to a time of day or a time range.

In an advantageous embodiment, the presence of a valid attribute certificate and/or the presence of predetermined parameters of an attribute certificate are entered as further condition for a certificate in the positive list.

This has the advantage that various side conditions, which are given by various entries or parameters in an attribute certificate, are accessible for the validity check. By means of a different period of validity of attribute certificate and the certificate itself, side conditions can also be set only delimited in time.

In an advantageous embodiment, during or after an updating of the positive list of the device, all communication links which have been set up from the device to a communication partner with a certificate no longer permitted are ended and newly set up or new session negotiation procedures are initiated.

This guarantees that after an updating of the positive list communication relations which are now no longer permitted are also actually ended, especially if such a communication link was actively in existence before the updating. Thus, existing communication links are also checked during an updating of the positive list.

In a further advantageous exemplary embodiment, the certificates of the communication partners are arranged in a positive list in dependence on the frequency of their utilization.

This accelerates the period of connection set up and thus leads to an optimized set up of a connection to the most frequently contacted communication partners.

In one exemplary embodiment, the arrangement of the certificates in the positive list is adapted dynamically during the period of validity of the positive list.

This enables the entries in the positive list to be reorganized in the case of a change in the frequency of communication relations and thus a fast communication set up to the altered most frequently utilized communication partners to be provided again.

In an advantageous embodiment, the target frame is specified as a parameter in a positive list by a string of text characters and/or by an IP address and/or by a server name and/or by an object identifier.

By means of the designation of a positive list by a chain of text symbols, the target frame of the positive list can be distinguished in a simple manner. An identification of the target frame of the positive list by means of an IP address or a server name makes it possible to allocate the positive list, for example, to the location of generation or the distribution point of the positive list.

The list management apparatus according to embodiments of the invention for providing a positive list for a device in a communication environment comprises an input unit which is designed to identify a target frame for the device by an input, a configuration unit which is designed to ascertain all or permitted communication partners from a total quantity of possible communication partners for the identified target frame and to produce therefrom a positive list which in each case comprises a certificate for each ascertained permitted communication partner, and an output unit which conveys the target-frame-specific positive list to the device.

Such a list management apparatus has the advantage that for a device or a target frame, respectively, of a device the certificates of all permitted communication partners are created before a first communication and conveyed to the device. Subsequently, the device can independently check during a further communication enquiry whether this is a permitted communication partner. A permanent link between a device and, for example, an access control server or else the list management apparatus is not necessary.

In an advantageous embodiment, the configuration unit is designed to perform updating of the positive list. This enables the permitted communication partners, if necessary, for example during a reconfiguration of the device, to be changed centrally and entered into the device. During a reconfiguration of the entire communication network, an efficient, structured distribution of the positive lists, for example in accordance with the new target frame of a device group, can be performed by the list management apparatus.

In an advantageous embodiment the output unit conveys the positive list, signed and via a local or secured link, to the device. The device then preferably has a positive list key with which cryptographic test information of a provided positive list is tested for use by the device. This positive list key can be predefined here or it can be provided by a higher-level positive list with entries of lower-level positive lists.

This reduces a possibility of manipulation of the positive list during the transmission to the device.

In an advantageous embodiment, the configuration unit comprises a filter which arranges the certificates in the positive list in an order corresponding to the frequency of their utilization.

This allows the entries to be ordered in the positive list already during their creation in accordance with the frequency of their utilization which has been determined, for example, by evaluations of statistics of previous utilization.

The device according to embodiments of the invention for the certificate-based authentication or communication partners in a communication environment comprises a storage unit which is designed to store a positive list with permitted certificates, an authentication unit which is designed to check a certificate of a purported communication partner against the permitted certificates in the positive list, with a communication being permitted only if the certificate of the purported communication partner matches a certificate in the positive list.

This has the advantage that the device can identify permitted communication partners even without a permanent link to an access control server and even without a permanent link to a list management apparatus.

In an advantageous embodiment, a device comprises one or more target-frame-specific positive lists.

This has the advantage that a device can work for different purposes and, during this process, different permitted communication partners can be selected. This increases the flexibility of the device with continuously high security with respect to a penetration of communication partners not permitted.

In an advantageous embodiment, the storage unit comprises a filter which arranges the permitted certificates in the target-frame-specific positive list in an order corresponding to the frequency of their utilization.

This provides for a dynamic adaptation of the order of the positive list in the device itself and in dependence on the current frequency of communication links.

The computer program product according to embodiments of the invention comprises program commands for performing the method in accordance with the aforementioned method claims.

The data carrier according to embodiments of the invention stores the computer program product according to claim 16 and can be used for installing the method in a list management apparatus and a device.

### BRIEF DESCRIPTION

Some of the embodiments will be described in detail, with reference to the following figures, wherein like designations denote like members, wherein:

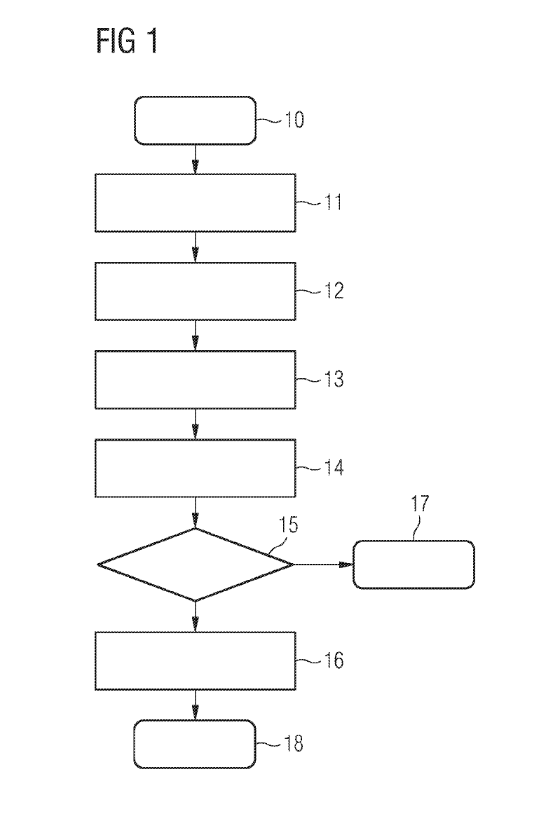

FIG. 1 shows an exemplary embodiment of the method according to the invention in the form of a flow chart;

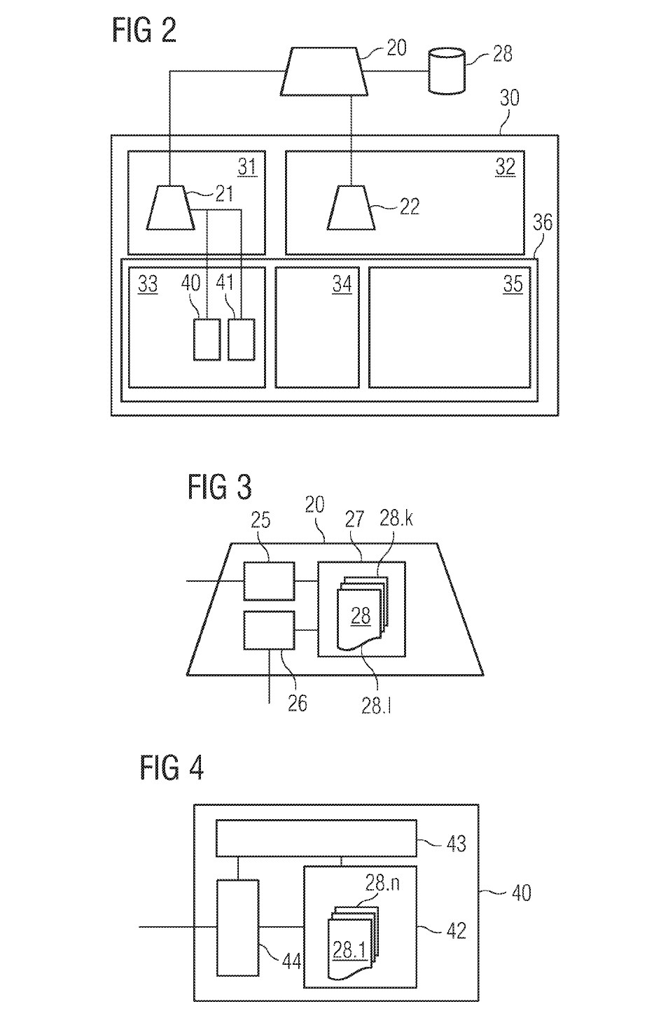

FIG. 2 shows an exemplary communication environment with an embodiment according to the invention of a list management apparatus in a diagrammatic representation;

FIG. 3 shows an exemplary embodiment of a list management apparatus according to the invention in diagrammatic representation; and

FIG. 4 shows an exemplary embodiment of a device according to the invention in diagrammatic representation.

Parts corresponding to one another are provided with the same reference symbols in all the figures.

### DETAILED DESCRIPTION

Using FIG. 1, the method according to embodiments of the invention for a certificate-based authentication in a communication environment will now be explained. The basic concept consists in generating one or more specific positive lists for a device depending on a target frame such as, for example, a device type or a device class or also for a purpose of use of a device or the geographic location of use of a device. In this context, the positive lists only contain the certificates or, for example, hash values of certificates of communication partners with which communication is permitted.

The method begins at state 10 in which a device receives a first communication request from a communication partner in the communication network. Subsequently, in method step 11, a target frame for the device is identified. The target frame can here be, for example, an indication of a device type but also of a single device or a group of devices. But the target frame can also be a purpose of use of the device such as, for example, the utilization of a device for a service access, the use of the device for control data transmission or the use of the device for the transmission of diagnostic data.

In the subsequent method step 12, all permitted communication partners from a totality of possible communication partners are ascertained for this identified target frame. This takes place in a list management apparatus which, for example, has an at least temporary link to a planning server or an access control server or is integrated into these.

In method step 13, a positive list specific for the target frame is generated from this which in each case comprises a specific certificate for each ascertained permitted communication partner. The permitted certificate can be identified, for example, by a serial number of the certificate or also, for example, by a characteristic quantity such as, for example, a hash value of the certificate and/or the hash value of a public key, and entered.

The selection of the permitted communication partners can also be performed here in dependence on predetermined parameters in the certificate of the communication partner. In particular, the predetermined parameters can also be contained in an attribute certificate for the certificate of the communication partner and utilized for the selection of the permitted communication partners.

Side conditions with respect to the validity of a certificate can be entered in the positive list. Such a condition can be, for example, an operating mode of the device or a time of day. But the existence and/or the validity of an attribute certificate can also be a condition. The certificate of a certificate entry contained in the positive list should be accepted as valid only if there is additionally an attribute certificate which meets the specified criteria mentioned in the positive list, for example specified parameters.

After the generation of the positive list, it is stored on the device in method step 14.

The generation of one or a multiplicity of target-frame-specific positive lists including the identification of the target frame and the determination of the permitted communication partners, see method steps 11, 12 and 13, can also be carried out during the installation and commissioning of a communication environment, for example the installation of an automation system with automation devices connected via a communication network, or else before the first commissioning of a new device in a communication environment. The positive list can then be transmitted from the communication environment to the device and stored, for example, during a first communication enquiry of a communication partner, see method step 14. But the positive list can also be recorded on the device before the device is introduced into the communication environment.

If the device subsequently receives a request of a communication partner to set up a communication relation, the certificate received in the device from a purported communication partner is checked against the certificates in the stored positive list in method step 15. If the certificate of the purported communication partner matches a certificate in the positive list, and if the certificate meets the secondary conditions mentioned in the positive list, communication is permitted, see method step 16, and a communication link is set up, see method step 18.

If the certificate conveyed by the purported communication partner does not match the certificates in the positive list or, respectively, the certificate does not meet the side conditions mentioned in the positive list, the communication request is refused, see method step 17.

A device can store different positive lists for different target frames such as, for example, different purposes of use. However, a device only accepts those positive lists which have a target frame fitting the device.

Thus, the device can independently check the permissibility of a communication with a purported communication partner without checking the validity at each communication enquiry by an enquiry at, for example, an access control server. In addition, the possible communication partners are restricted to the certificate owners mentioned in the positive list. This provides for a simple and thus rapid and fault-resistant certificate validation on the device.

A positive list itself is structured, for example, in accordance with a specification RFC 5280 which is also used for a certificate revocation list. It comprises as parameter the target frame which is specified as text character string or else alternatively or additionally by an IP address, by a server name or by an object identifier. A combination of the different parameters is also possible. The positive list can also contain information about the issuer of the positive list and comprise information on the validity period of the positive list. The positive list can be updated after the validity period has expired or when the validity date is exceeded or also by a change in the communication environment. For this purpose, the positive list is checked and updated advantageously in a list management apparatus which is constructed, for example, in a central management node or also in a corresponding apparatus or on the device itself

After the updating of the positive list, it is conveyed or provided again to the device. After obtaining an updated positive list, all existing links, particularly secure links which are set up and operated by means of a transport layer protocol such as, e.g. SSL, TLS or also IPsec, are terminated and subsequently set up again in the device. Alternatively, a renovated session negotiation procedure can be initiated. In both cases, the certificate of the communication partner is checked for each link. This ensures that a communication link is set up only with the communication partners which are contained in the updated positive list.

However, the entries of the updated positive list can also be tested against the entries of the old positive list. Existing communication links are checked and terminated only for altered or deleted entries, or terminated and a re-setup or a session negotiation procedure initiated, respectively.

The entries of the positive list can be arranged in dependence on the frequency of their utilization, for example corresponding to the real-time requirements of a link or other criteria, for example priority services of the communication partner. The arrangement of the certificates of the communication partners can be performed already during the creation of the positive list. However, the arrangement of the certificates can also be adapted dynamically during the validity period of a positive list and in the device itself in which it is stored and in which it is applied.

Since during the application of such probabilistic data structures, wrong assessments of individual certificates may occur, it can be checked additionally that no other device of the issuing certification office is inadmissibly indicated as valid by the Bloom filter. By means of such a targeted arrangement of the entries in the positive list, the duration of the connection set-up can be shortened and, in particular, fast communication can be ensured for important applications.

FIG. 2 shows a communication environment 30 comprising a multiplicity of devices 40, 41 which are in each case arranged in groups having in each case different target frames 31 to 36, for example for the transmission of sensor data to a higher-level node in the communication environment. The structuring or allocation, respectively, of the devices in groups 31 to 36 could also correspond to a functional structure of an automation or energy control installation.

The positive lists for the devices 40, 41 are produced, for example, in a higher-level list management apparatus 20 in each case for different target frames. These positive lists are conveyed to lower-level list management apparatuses 21, 22 which, for example, check whether the issuer of the positive list was a trustworthy entity. This can be checked by the signature of a positive list or by means of the trustworthiness of the issuer of the signature, respectively. A lower-level list management apparatus 21, 22 thereupon generates device-specific positive lists which it signs again. Thus, the trustworthiness or authenticity, respectively, for example, of the positive list conveyed to the device can be ensured.

FIG. 3 describes the structure of a list management apparatus 20 in greater detail. It comprises an input unit 25 which is connected to a configuration unit 27. This, in turn, is connected to an output unit 26. The input unit 25 is designed to identify a target frame for the device 40, 41 by means of an input. This input can be input, for example, by the planning server represented in FIG. 2, or another access control server or else supplied by the device itself. The configuration unit 27 is designed to ascertain all permitted communication partners from a totality of possible communication partners for the identified target frame and to create therefrom a positive list 28 which in each case comprises a certificate for each ascertained permitted communication partner. In this context, the list management apparatus 20 can comprise a large number of different positive lists 28.k, . . . , 28.1 for in each case different target frames.

These positive lists 28.k, . . . , 28.1 are transferred when needed or after updating to a device 40, 41 or a lower-level list management apparatus 21, 22 via the output unit 26. The output unit 26 is designed in such a manner that it conveys the positive lists, signed 28.k, . . . , 28.1 and via a local and/or secured link, to the device 40, 41. The configuration unit 27 comprises a filter, for example a Bloom filter which arranges the permitted certificates in the positive list 28.k, . . . , 28.1 in accordance with the frequency of their utilization. Other criteria for the arrangement of the permitted certificates such as, for example, the importance of different communication partners for the function of the communication environment are additionally possible.

FIG. 4 shows a device 40. It comprises a storage unit 42, an authentication unit 43 and an input and an output unit which is shown here as combined input/output unit 44. The storage unit 42, the authentication unit 43 and the input/output unit 44 are in each case connected to one another.

In this arrangement, the storage unit 42 is designed to store one or, respectively, a number of positive lists 28.1, . . . , 28.n which have been assigned to the device 40 for different fields of application. The authentication unit 43 is designed to check a certificate of a purported communication partner against the permitted certificates in the positive list 28 and the conditions possibly specified there. A communication is allowed and subsequently set up only when the certificate of the purported communication partner matches a certificate in the positive list 28, for example 28.n, for a particular target frame. In this context, the storage unit 42 comprises a filter which arranges the permitted certificates dynamically, for example in an order corresponding to the frequency of their utilization. In the case of a change of the frequency of the communication link, this enables the list to be adapted thereto and also an optimized connection setup period in the case of the altered communication characteristic to be provided.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A method for a certificate-based authentication of communication partners in a device, comprising the method steps:
identifying a target frame for the device;
ascertaining all permitted communication partners for the identified target frame from a total quantity of possible communication partners;
producing a positive list specific to the target frame, which in each case comprises a certificate for each ascertained permitted communication partner;
storing the positive list on the device; and
checking a certificate received from a purported communication partner in the device against the certificates in the positive list, with a communication between the device and the purported communication partner being permitted only if the certificate of the purported communication partner matches a certificate in the positive list.

2. The method as claimed in claim 1, wherein the target frame of the device is identified by a specification of a device type and/or of a purpose of use of the device and/or of a permitted geographic field of use of the device.

3. The method as claimed in claim 1, wherein side conditions relating to a validity of a certificate are entered in the positive list.

4. The method as claimed in claim 3, wherein a presence of a valid attribute certificate and/or a presence of predetermined parameters of an attribute certificate are entered as side condition for the certificate in the positive list.

5. The method as claimed in claim 1, wherein, during or after an updating of the positive list of the device, all communication links which have been set up from the device to a communication partner with a certificate no longer permitted are ended and newly set up or session negotiation procedures are initiated.

6. The method as claimed in claim 1, wherein the certificates of the communication partners are arranged in the positive list in dependence on the frequency of their utilization.

7. The method as claimed in claim 6, wherein the arrangement of the certificates in the positive list is adapted dynamically during the period of validity of the positive list.

8. The method as claimed in claim 1, wherein the target frame is specified as a parameter in a positive list by a string of text characters and/or by an IP address and/or by a server name and/or by an object identifier.

9. The method as claimed in claim 1, wherein a target-frame-specific positive list already produced is selected and conveyed to the device when a target frame is identified for which a target-frame-specific positive list has already been produced.

10. A list management apparatus for providing a positive list for a device in a communication environment, comprising:
an input unit which is designed to identify a target frame for the device by an input;
a configuration unit which is designed to ascertain all permitted communication partners from a total quantity of possible communication partners for the identified target frame and to produce therefrom a positive list which in each case comprises a certificate for each ascertained permitted communication partner; and
an output unit which conveys the target-frame-specific positive list to the device.

11. The list management apparatus as claimed in claim 10, wherein the configuration unit is designed to perform updating of the positive list.

12. The list management apparatus as claimed in claim 10, wherein the output unit conveys the positive list, signed and via a local and/or secured link, to the device.

13. The list management apparatus as claimed in claim 11, wherein the configuration unit comprises a filter which arranges the certificates in the positive list in an order corresponding to the frequency of their utilization.

14. The list management apparatus as claimed in claim 10, wherein the configuration unit is designed to store a multiplicity of target-frame-specific positive lists and, in identifying a known target frame, to select the positive list corresponding to the known target frame and convey it by the output unit to the device.

15. A device for the certificate-based authentication of communication partners in a communication environment comprising a storage unit which is designed to store a positive list with permitted certificates, an authentication unit which is designed to check a certificate of a purported communication partner against the permitted certificates in the positive list, with a communication being permitted only if the certificate of the purported communication partner matches a certificate in the positive list.

16. The device as claimed in claim 15, wherein a device comprises one or more target-frame-specific positive lists.

17. The device as claimed in one of claim 15, wherein the storage unit comprises a filter which arranges the permitted certificates in the positive list in an order corresponding to the frequency of their utilization.

18. A computer program product with program commands for performing the method as claimed in claim 1.

19. A data carrier which stores the computer program as claimed in claim 18.
